(19) United States
(12) Patent Application Publication
(10) Pub. No.: US 2009/0287497 A1
(43) Pub. Date: Nov. 19, 2009

(54) Real-time profile-matched peer to peer personal crisis response

(76) Inventor: Stephen J. Brown, Woodside, CA (US)

Correspondence Address: LUMEN PATENT FIRM, 350 Cambridge, Suite 100, PALO ALTO, CA, 94306, US

(21) Appl. No.: 12/152,774

(22) Filed: May 16, 2008

(51) Int. Cl. G06Q 99/00

(52) U.S. Cl. 705/1

(57) ABSTRACT

Real-time profile-matched peer to peer personal crisis response is provided. A personal crisis can be related to a behavioral change, such as weight loss. A user of a computer implemented social network undergoing a personal crisis can make a request for help to be broadcasted to other users. Another user can select the requesting user to provide help to the help requester. The helper and requester are connected through a real-time communication. Rating capabilities are also provided for the requester to rate the helper. Users of the social network have user profiles and user attributes used for matching a potential helping user with the appropriate requesting users. User matching can also be based on the user ratings.

### FIELD OF THE INVENTION

The invention relates generally to connecting online users. More particularly, the present invention relates to connecting users for real-time profile-matched peer to peer personal crisis response.

### BACKGROUND

There is a widespread desire to undergo personal behavioral modification, such as losing weight or ending an addiction. However, making lasting changes to personal behavior can be a daunting task. Traditional methods for changing personal behavior, such as expert advice, diet plans, books, and videos, often fail due to their lack of motivation and accountability. Internet-based programs dedicated for some personal behavior changes are currently available, though they often suffer from the same deficiencies as the more traditional methods.

Personal behavioral modification can be difficult even for motivated individuals. Though motivated individuals may be able to change their behavior under ordinary circumstances, during a personal crisis or triggered state, it is easy for an individual to revert to habitual behavior. For examples with addictive behavior, such as an eating or a smoking habit, triggered states induced by stress or temptations can lead to giving in to the addictive behavior. Commonly, these momentary or temporary reversions to habitual behavior prevent individuals from making lasting changes to their personal behavior.

Emergency response centers are available for medical or life-threatening emergencies. Existing emergency response centers require a centralized call center with dispatchers available whenever an emergency occurs. Typically, an emergency is called into the response center and a dispatcher then alerts professional emergency responders, such as police officers, fire officers, or medical professionals, to attend to the emergency. In addition to requiring a large amount of infrastructure and cost, existing emergency response centers can often be overwhelmed when a large number of emergencies exist simultaneously. Furthermore, emergency response centers are generally only appropriate for medical, criminal, or life-threatening emergencies.

The present invention at least addresses the problem of behavioral modification and personal crises related to the behavioral modification.

### SUMMARY OF THE INVENTION

The present invention is directed to helping individuals overcome the triggered states by connecting help requesting users, called requesters, and help providing users, called helpers of a computer implemented social network. The users of the social network has a user profile, wherein the user profile of a requester includes one or more requester attributes and the user profile of a helper includes one or more helper attributes. The requester and helper attributes can include a physical need, an emotional state, or both.

A request function is provided for allowing one or more users to make requests for help and a help function is provided for a user to select one of the requesters to provide help to the requester. The requests for help are preferably related to a weight loss goal, an exercise regimen, a diet regimen, a lifestyle change, a smoking habit, a drug habit, an addiction, or any combination thereof. After the selection of the requester, the helper is connected to the selected requester and a communication is initiated between at least the helper and the selected requester. The communication can include a telephone communication, an instant messaging session, an online chat, an online phone chat, or an online video chat. Optionally, the communication can include a phone conference, an online group chat, an online group audio chat, or an online group video chat between the requester, the helper, and another user of the social network.

A rating function is also provided for a selected requester to rate the helper, wherein the rating is based on the quality of the communication and the rating is related to at least one of the requester attributes of the selected requester. The rating function can also allow the helper to rate one or more of the selected requester based on the communication.

In a preferred embodiment, one or more of the requesters are matched with a helper and the help function allows the helper to select one or more of the matched requesters. Matching can be at least partially based on at least one of the requester attributes of the requesters and at least one of the helper attributes of the helper. Matching can also be at least partially based on the ratings of a helper. One or more of the requesters can also be ranked for a helping user to form a ranked list. The help function allows the helper to select one or more of the ranked requesters from the rank list. Ranking can be at least partially based on at least one of the requester attributes of the ranked requesters and at least one of the helper attributes of the helper viewing the ranked list.

### BRIEF DESCRIPTION OF THE FIGURES

The present invention together with its objectives and advantages will be understood by reading the following description in conjunction with the drawings, in which:

FIG. 1 shows an example of matching requesting users R₁-R_{N} to a helping user H and connecting a requesting user with a helping user according to the present invention.

FIG. 2 shows an example of a user profile for a requesting user according to the present invention.

FIG. 3 shows an example of a user profile for a helping user according to the present invention.

FIG. 4 shows an example of a ranked list of requesters for a helping user according to the present invention.

FIG. 5 shows an example of a graphical user interface for a rating function according to the present invention.

FIG. 6 shows an example of multiple requesters R rating a helper H according to the present invention.

FIG. 7 shows an example of a computer implemented social network of requesting and helping users according to the present invention.

### DETAILED DESCRIPTION OF THE INVENTION

Undergoing a personal behavioral change, such as losing weight or quitting an addiction, can be a daunting task. Oftentimes, attempts at behavioral modification fail because a person succumbs to momentary lapses or cravings. To succeed at fulfilling personal goals of behavioral modification, assistance is generally needed to overcome these triggered states. Below is a detailed description of real-time profile-matched peer to peer personal crisis response in a computer implemented social network of users.

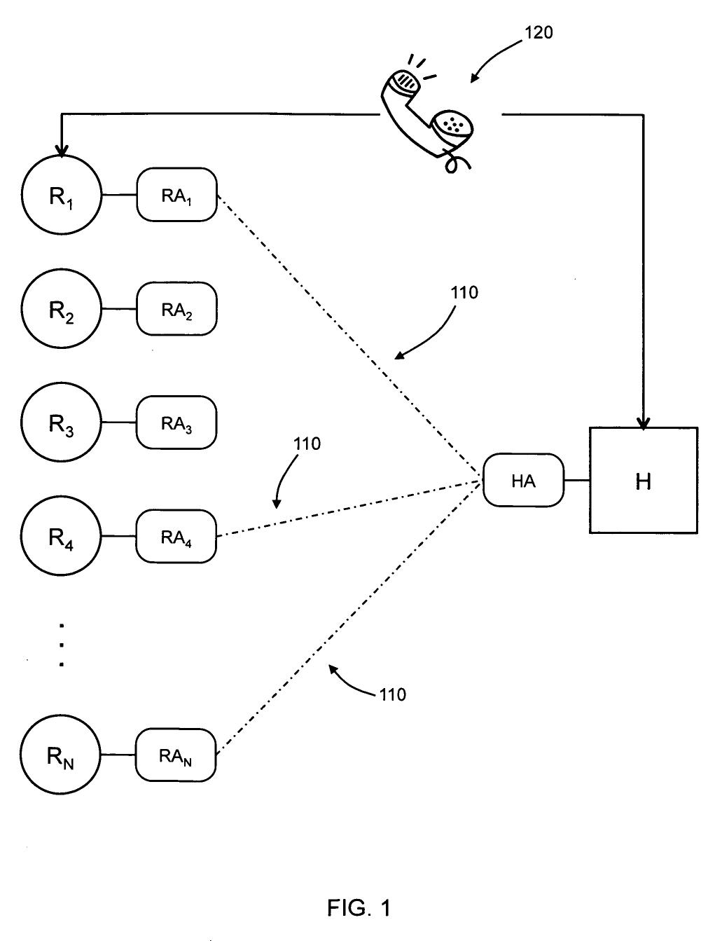

FIG. 1 shows multiple users of a computer implemented social network, preferably a social network related to a personal behavioral modification. A request function is provided for at least some of the users to request help, where the help request can be for a personal crisis related to the personal behavioral modification. Users requesting help are called help requesters R₁-R_{N}. Importantly, the help requests are not sent to a centralized call center, instead, the help requests are broadcasted in a peer to peer manner to one or more other users of the social network. A help function is provided for a user to select one or more of the requesters R₁-R_{N} and provide help to the requester R₁-R_{N}. A help providing user is called a helper H.

After a helper H selects a requester R₁, a communication 120 between the helper H and the selected requester R₁ is initiated. It is believed that a requester's momentary cravings or lapses can be more easily overcome by interactions with another user. Though a helping user H can be an expert or professional, a user need not have any certified qualifications to be a helper H. Preferably, the communication 120 includes a real-time communication, such as a telephone communication, an instant messaging session, an online chat, an online phone chat, an online video chat, or any combination thereof.

In an optional embodiment, the communication 120 can involve more than two users, particularly for situations in which larger group interactions are helpful. The larger group communication 120 between a requester R, a helper H, and another user of the social network can include a phone conference, an online group chat, an online group audio chat, an online group video chat, or any combination thereof.

It is important to note that each of the users of the social network has a user profile with user attributes. The user profiles of the requesting users R₁-R_{N} include one or more requester attributes RA and the user profile of a helping user H includes one or more helper attributes HA. In a preferred embodiment, one or more of the requesters R₁-R_{N} are matched 110 with the helper H based on at least one of the requester attributes RA and at least one of the helper attributes HA.

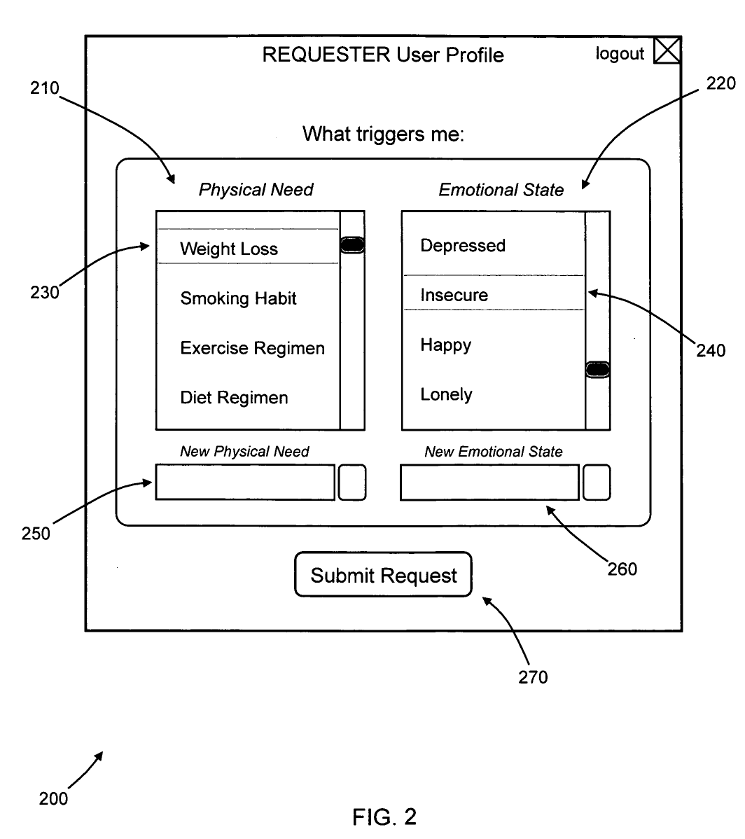

FIG. 2 shows an example user profile 200 with requester attributes for a help requesting user. The requester attributes are related to situations when the requester requires help. In a preferred embodiment, one or more requester attributes includes a physical need 210, an emotional state 220, or both. Physical needs can be related to a weight loss goal, an exercise regimen, a diet regimen, a lifestyle change, a smoking habit, a drug habit, an addiction, or any physical situation related to behavioral modification. Example emotional states for requester attributes include, but are not restricted to: bad, better, good, guilty, sick, sorry, well, down, alone, happy, great, sad, lost, tired, lonely, horrible, pretty, special, loved, depressed, fine, confident, big, important, complete, fat, proud, stressed, helpless, angry, ashamed, needed, scared, beautiful, hungry, satisfied, handsome, frustrated, insecure, calm, emotional, and motivated. In an embodiment, the requester attributes of a requester are extensible; a requester can edit or create new requester attributes, such as a new physical need 250 and/or a new emotional state 260.

In a preferred embodiment, a user makes a help request by selecting or entering one or more requester attributes and submitting 270 the request. The requester of FIG. 2 selects a physical need 230 and/or an emotional state 240 to indicate what is currently triggering the requester. In an alternative embodiment, a help request is submitted without selection of any requester attributes. The help request can be made through a computer connected to a network, such as the Internet. Help requests can also be made through a phone, a mobile phone, a personal digital assistant, a laptop, a wireless device, or an electronic device capable of connecting to a computer network. A device specifically dedicated to making help requests can also be used, wherein the device includes a button for sending help requests.

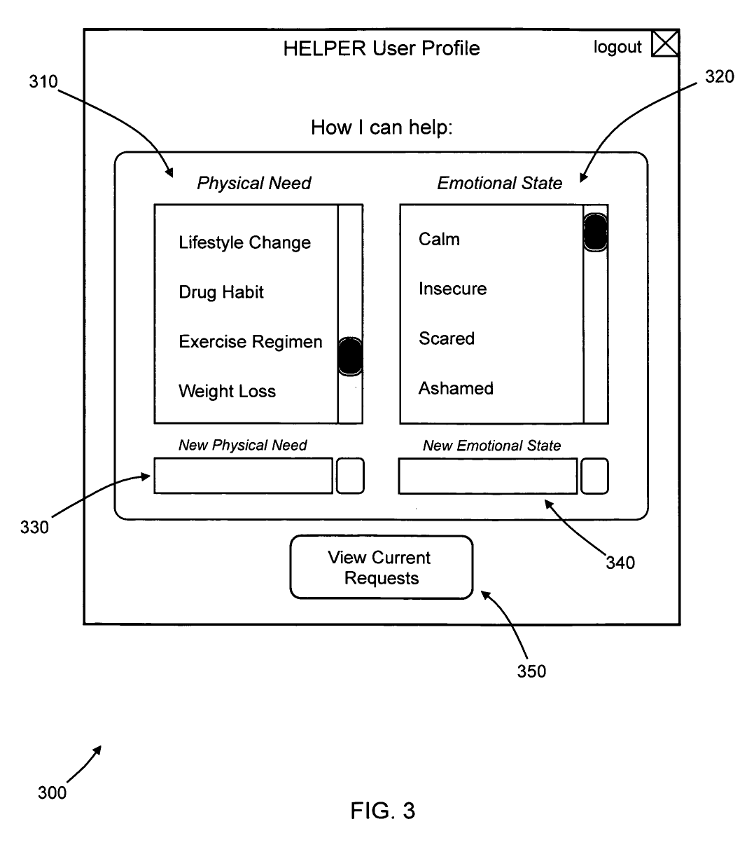

FIG. 3 shows an example user profile 300 with helper attributes for a helping user. The helper attributes can be related to situations when the user can provide help. In a preferred embodiment, one or more of the helper attributes are the same or similar to the requester attributes of a requesting user. For example, helper attributes can include a physical need related to a weight loss goal, an exercise regimen, a diet regimen, a lifestyle change, a smoking habit, a drug habit, an addiction, or any physical situation related to behavioral modification. Helper attributes can also include emotional states, such as bad, better, good, guilty, sick, sorry, well, down, alone, happy, great, sad, lost, tired, lonely, horrible, pretty, special, loved, depressed, fine, confident, big, important, complete, fat, proud, stressed, helpless, angry, ashamed, needed, scared, beautiful, hungry, satisfied, handsome, frustrated, insecure, calm, emotional, and motivated. Optionally, a helper can edit or create new helper attributes, such as a new physical need 330 and/or a new emotional state 340.

In an embodiment, the help function allows a user to view the current help requests 350 and select one or more requesters to provide help. Preferably, one or more requesters are matched with the potential help providing user, where the matching is at least partially based on the user profiles 200 of the requesters and the user profile 300 of the helper. For example, a helper with a helper attribute related to a smoking addiction will be preferentially matched with requesters with requester attributes related to smoking addiction over requesters with requester attributes related to weight loss.

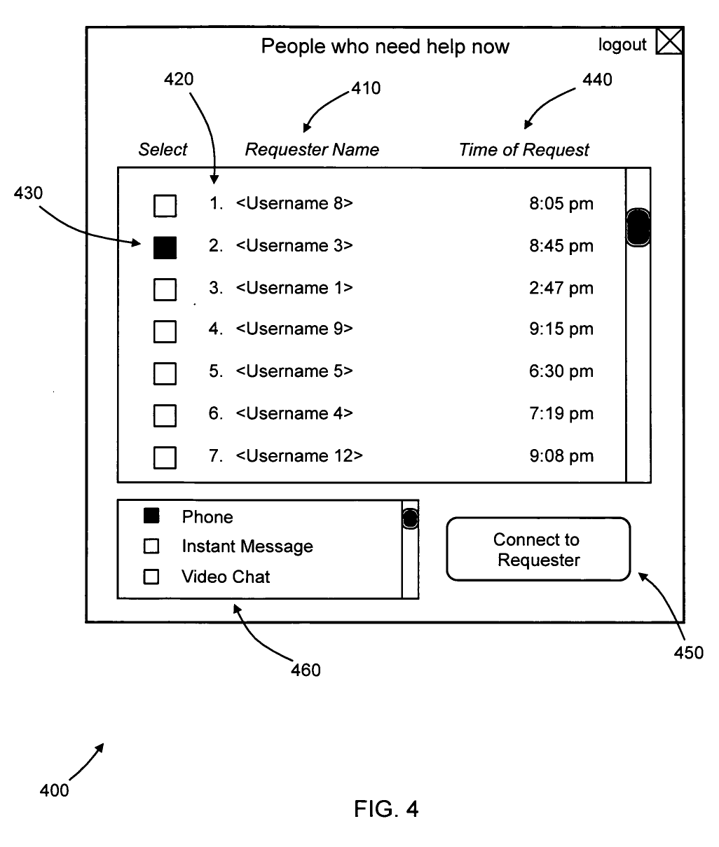

The current help requests can also be displayed in the form of a list 400, as shown by FIG. 4. The list 400 can display the name or username of the requesters 410. Optionally, the list can also display one or more requester attributes of the requester and other details related to the requests or the requesters. In a preferred embodiment, the help requests displayed to a helping user are ranked 420. The ranking can be at least partially based on at least one of the requester attributes of the requesters and at least one of the helper attributes of the helper viewing the list. Alternatively, the ranking can be based on the time 440 the request was made, or based on any other property of the requesters, requests, and/or helper. A helper can select 430 a requester from the list 400 and connect to the requester 450. Optionally, modes of communication, such as phone numbers, email address, and usernames and preferences of modes of communication can be stored. In an embodiment, the helper can choose the mode of communication 460.

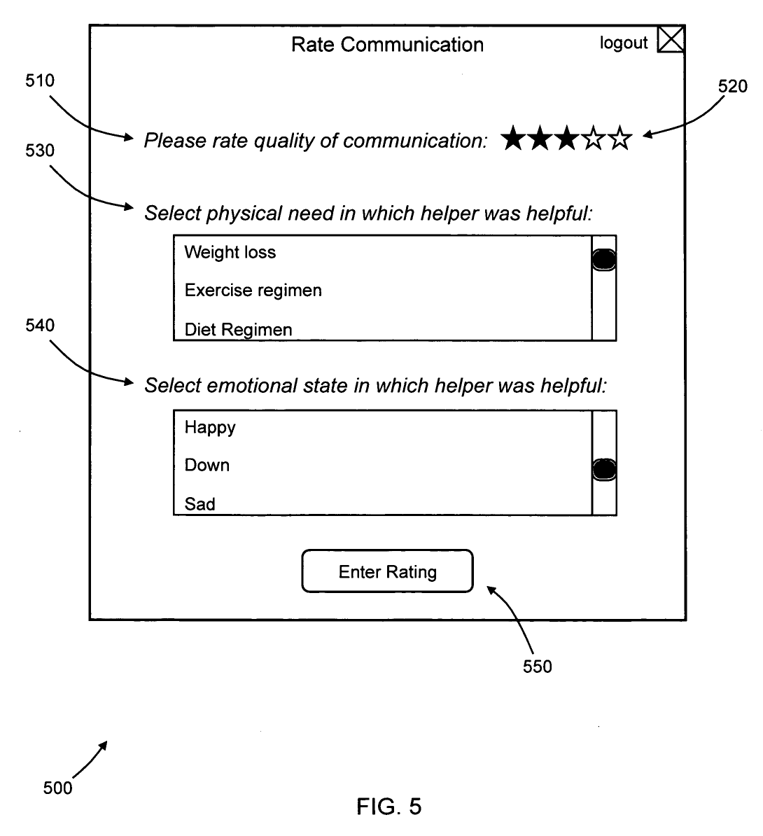

It is important to note that a rating function 500 is provided for a requester to rate a helper during or after the communication between the helper and the requester. An example rating function 500 is shown in FIG. 5. The rating allows the requester to rate the quality of the communication 510 and the rating can be related to one or more requester attributes of the requester, such as a physical need 530 and/or an emotional state 540. The rating metric can include a number of stars 520, a numerical rating, a binary rating, an alphabetical rating, a grade, an alphanumerical rating, a survey, a comment, or any combination thereof.

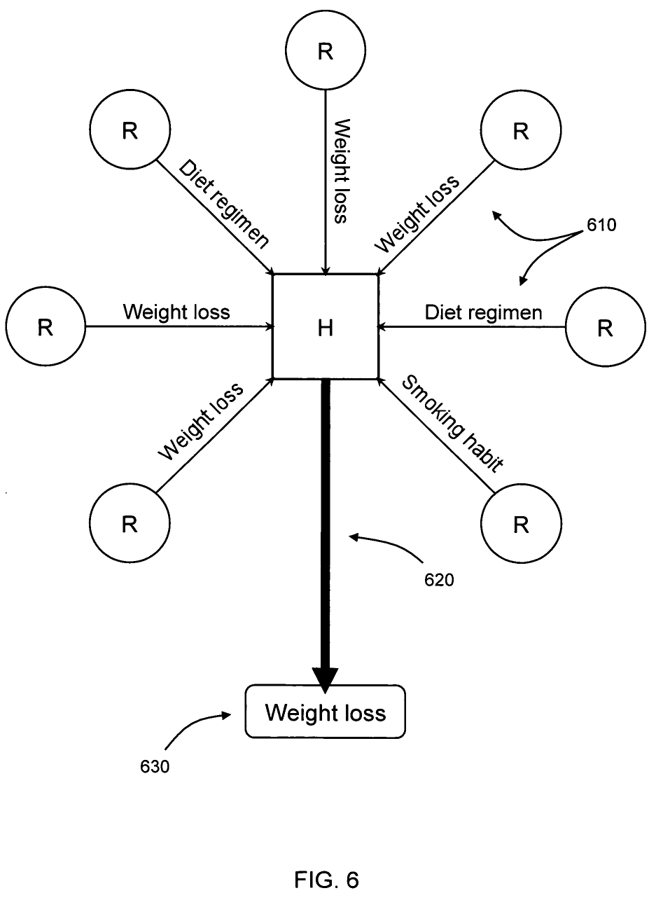

In a preferred embodiment, the rating function 500 allows the requester to tag the helper with one or more requester and/or helper attributes. For example, a requester can make a tag to denote that a helper is particularly helpful for triggers involving weight loss and when someone is sad. FIG. 6 shows how multiple ratings and tags 610 can be used to determine what situation, category, or attribute fits best with a particular helper H; an accumulation of ratings and/or tags 610 for a helper H by multiple requesters R contributes to a helper attribute of helper H. For example, FIG. 6 shows that the majority of requesters R find the physical need where helper H is most helpful is related to weight loss, thus a weight loss helper attribute is assigned 620 to helper H. The assignment 620 can be based on an average, a weighted average, a majority, a quorum, or any other measure. In addition, the assignment 620 can change over time as more requester ratings of the helper are made.

It is important to note that the ratings can be used for matching requesters with helpers or for ranking requesters on a ranked list 400. For example, requests related to weight loss would be ranked higher for a helper with a weight loss helper attribute established by a plurality of previous requester ratings. From these peer ratings-based matching and/or ranking, requesting users are more likely to be connected to a helping user who will be able to help them overcome their triggered states. In an optional embodiment, the rating function allows a helper to also rate a requester during or after the communication between the helper and the requester.

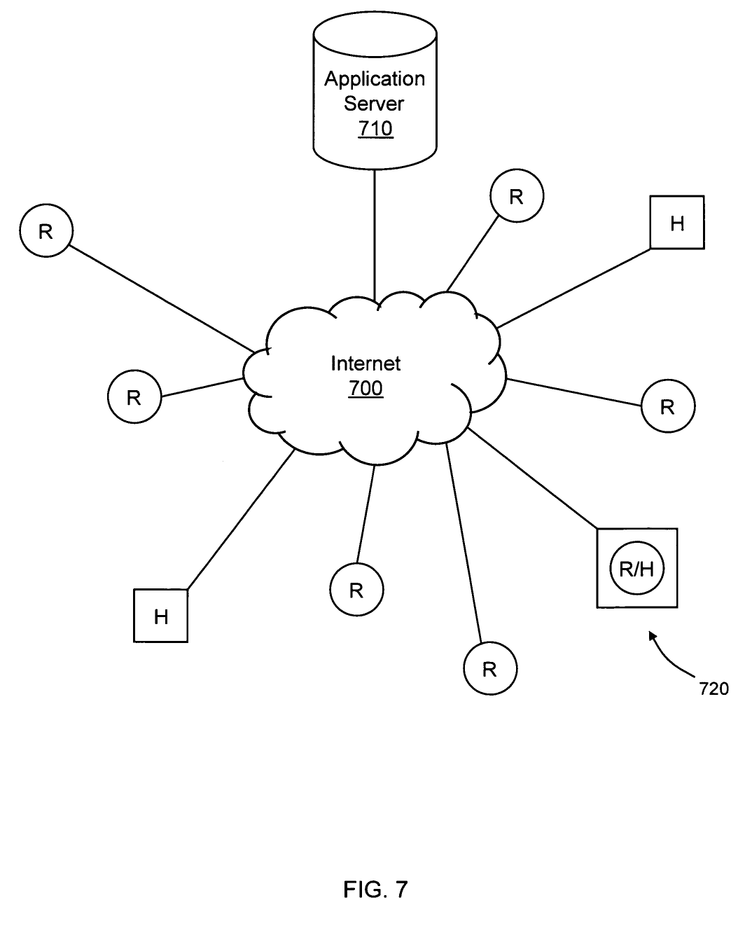

FIG. 7 shows an application server 710 operating a computer implemented social network of users. The users of the social network include requesters R and helpers H. It is noted that a user can act as both, a requester and a helper 720, thereby having both requester and helper attributes. A user communicates with other users of the social network through a network, such as the Internet 700. The connections can be through personal computers, laptop computers, mobile phones, personal digital assistants, and any other devices known in the art.

As one of ordinary skill in the art will appreciate, various changes, substitutions, and alterations could be made or otherwise implemented without departing from the principles of the present invention, e.g. the Internet could be substituted by a local area network and the requester or helper attributes can include any physical needs and/or emotional states. Accordingly, the scope of the invention should be determined by the following claims and their legal equivalents.

What is claimed is:

1. A method for connecting users, comprising:
(a) having a computer implemented social network of a plurality of users, wherein each of said plurality of users has a user profile;
(b) providing a request function for allowing one or more of said users to make a request for help, wherein said users making said requests for help are called requesters, wherein said user profile for each of said requesters comprises one or more requester attributes;
(c) providing a help function for at least one of said users to select one or more of said requesters and to provide help to said selected requesters, wherein said help providing user is called a helper, wherein said user profile for each of said helpers comprises one or more helper attributes;
(d) connecting said helper with each of said selected requesters, wherein said connection initiates a communication between at least said helper and the same of said selected requesters; and
(e) providing a rating function for allowing each of said selected requesters to rate said helper, wherein said rating is based on the quality of said communication, and wherein said rating is related to at least one of said requester attributes of the same of said selected requesters.

2. The method as set forth in claim 1, wherein said one or more requester attributes comprises:
(a) at least one physical need;
(b) at least one emotional state; or
(c) at least one physical need and at least one emotional state.

3. The method as set forth in claim 1, further comprising matching one or more of said requesters with said helper, wherein said help function allows said helper to select one or more of said matched requesters, and wherein said matching is at least partially based on at least one of said requester attributes of said requesters and at least one of said helper attributes of said helper.

4. The method as set forth in claim 3, wherein said matching is at least partially based on said ratings of said helper.

5. The method as set forth in claim 1, further comprising ranking at least some of said requesters to form a ranked list of requesters, wherein said help function allows said helper to select one or more of said ranked requesters from said ranked list, and wherein said ranking is at least partially based on at least one of said requester attributes of said requesters and at least one of said helper attributes of said helper.

6. The method as set forth in claim 1, wherein said rating function allows said helper to rate one or more of said selected requesters based on said communication.

7. The method as set forth in claim 1, wherein said communication between at least said helper and said selected requester comprises a telephone communication, an instant messaging session, an online chat, an online phone chat, an online video chat, or any combination thereof.

8. The method as set forth in claim 1, wherein said communication is between at least said helper, said selected requester, and another of said plurality of users, wherein said communication comprises a phone conference, a online group chat, an online group audio chat, an online group video chat, or any combination thereof.

9. The method as set forth in claim 1, wherein at least one of said requester attributes of one of said requesters is editable, and wherein at least one of said helper attributes of said helper is editable.

10. The method as set forth in claim 1, wherein said one or more requests for help are related to a weight loss goal, an exercise regimen, a diet regimen, a lifestyle change, a smoking habit, a drug habit, an addiction, or any combination thereof.

11. A system for connecting users, comprising:
(a) an application server for operating a computer implemented social network of a plurality of users, wherein each of said plurality of users has a user profile;
(b) a request function for allowing one or more of said users to make a request for help, wherein said users making said requests for help are called requesters, wherein said user profile for each of said requesters comprises one or more requester attributes;
(c) a help function for at least one of said users to select one or more of said requesters and to provide help to said selected requesters, wherein said help providing user is called a helper, wherein said user profile for each of said helpers comprises one or more helper attributes;
(d) a connection function for connecting said helper with each of said selected requesters, wherein said connection initiates a communication between at least said helper and the same of said selected requesters; and
(e) a rating function for allowing each of said selected requesters to rate said helper, wherein said rating is based on the quality of said communication, and wherein said rating is related to at least one of said requester attributes of the same of said selected requesters.

12. The system as set forth in claim 11, wherein said one or more requester attributes comprises:
(a) at least one physical need;
(b) at least one emotional state; or
(c) at least one physical need and at least one emotional state.

13. The system as set forth in claim 11, further comprising a matching function for matching one or more of said requesters with said helper, wherein said help function allows said helper to select one or more of said matched requesters, and wherein said matching is at least partially based on at least one of said requester attributes of said requesters and at least one of said helper attributes of said helper.

14. The system as set forth in claim 13, wherein said matching is at least partially based on said ratings of said helper.

15. The system as set forth in claim 11, further comprising a ranking function for ranking at least some of said requesters to form a ranked list of requesters, wherein said help function allows said helper to select one or more of said ranked requesters from said ranked list, and wherein said ranking is at least partially based on at least one of said requester attributes of said requesters and at least one of said helper attributes of said helper.

16. The system as set forth in claim 11, wherein said rating function allows said helper to rate one or more of said selected requesters based on said communication.

17. The system as set forth in claim 11, wherein said communication between at least said helper and said selected requester comprises a telephone communication, an instant messaging session, an online chat, an online phone chat, an online video chat, or any combination thereof.

18. The system as set forth in claim 11, wherein said communication is between at least said helper, said selected requester, and another of said plurality of users, wherein said communication comprises a phone conference, a online group chat, an online group audio chat, an online group video chat, or any combination thereof.

19. The system as set forth in claim 11, wherein at least one of said requester attributes of one of said requesters is editable, and wherein at least one of said helper attributes of said helper is editable.

20. The system as set forth in claim 11, wherein said one or more requests for help are related to a weight loss goal, an exercise regimen, a diet regimen, a lifestyle change, a smoking habit, a drug habit, an addiction, or any combination thereof.
